(19) United States
(12) Patent Application Publication
(10) Pub. No.: US 2024/0284582 A1
(43) Pub. Date: Aug. 22, 2024

(54) GAS SUPPLY FOR A PLASMA ARC MATERIAL PROCESSING SYSTEM

(71) Applicant: Hypertherm, Inc., Hanover, NH (US)

(72) Inventors: Jon Lindsay, Grantham, NH (US); Soumya Mitra, Lebanon, NH (US); John Sobr, Lebanon, NH (US)

(21) Appl. No.: 18/584,051

(22) Filed: Feb. 22, 2024

Related U.S. Application Data
(60) Provisional application No. 63/447,389, filed on Feb. 22, 2023.

(51) Int. Cl. H05H 1/34; B23K 10/00; H05H 1/36

(52) U.S. Cl. CPC H05H 1/3405; B23K 10/006; H05H 1/3473; H05H 1/36

(57) ABSTRACT

A gas supply system is provided for a gas-cooled plasma arc material processing system. The gas supply system includes a gas pressure control valve disposed relative to a gas-cooled plasma arc torch in the plasma arc material processing system and a gas selector valve fluidly connected to (i) at least two gas supplies and (ii) a torch lead coupled to the plasma arc torch. The gas selector valve located upstream from both the torch lead and the gas pressure control valve. The gas supply system also includes a switching device operably connected to the gas selector valve. The switching device is configured to manipulate a position of the gas selector valve to supply a gas from one of the at least two gas supplies to the plasma arc torch via the lead.

### CROSS REFERENCE TO RELATED APPLICATION

This application claims benefit of and priority to U.S. Provisional Patent Application No. 63/447,389, filed on Feb. 22, 2023, the entire content of which is owned by the assignee of the instant application and incorporated herein by reference in its entirety.

### TECHNICAL FIELD

The present invention generally relates to a gas supply system for a gas-cooled plasma arc processing system.

### BACKGROUND

Material processing apparatus, such as plasma arc torches and lasers, are widely used in the heating, cutting, gouging and marking of metallic materials known as workpieces. For example, a plasma arc torch generally includes a torch body, consumables, such as an electrode and a nozzle having a central exit orifice mounted within the torch body, electrical connections, and passages for cooling and are control fluids (e.g., plasma gas). Optionally, a swirl ring is employed to control fluid flow patterns in the plasma chamber formed between the electrode and the nozzle. In some plasma arc torches, a retaining cap can be used to maintain the nozzle and/or the swirl ring in the torch body. Gases used in the torch can be non-oxidizing (e.g., argon or nitrogen), or oxidizing (e.g., oxygen or air). A plasma arc torch is configured to produce a plasma arc, which is a constricted ionized jet of a plasma gas with high temperature and high momentum.

One method for producing a plasma are in a plasma arc torch is the contact start method. The contact start method involves establishing physical contact and electrical communication between the electrode and the nozzle to create a current path between them. The electrode and the nozzle can cooperate to create a plasma chamber within the torch body. An electrical current is provided to the electrode and the nozzle, and a process gas is introduced to the plasma chamber. Pressure of the process gas builds up until the pressure is sufficient to separate the electrode and the nozzle. The separation causes an arc to be formed between the electrode and the nozzle in the plasma chamber. Hereinafter, this plasma arc is referred to as a pilot arc and the torch operation with the arc attached to the nozzle is referred to as a pilot are mode. The pilot arc ionizes the introduced process gas to produce a plasma jet that can be transferred to the workpiece for material processing. Hereinafter, this plasma arc is referred to as a transferred are and the torch operation with the plasma arc transferred is referred to as a transferred arc mode. In some applications, a power supply connected to the plasma arc torch is adapted to provide a first electrical current known as a pilot current during generation of the arc in the pilot arc mode and a second current known as a transferred arc current when the plasma jet has been transferred to the workpiece in the transferred arc mode.

Certain components of the material processing apparatus deteriorate over time from use. These consumable components include, in the case of a plasma arc torch, the electrode, swirl ring, nozzle, and shield. In some cases, one or more consumable components are packaged together as a cartridge, where the set of consumable components in the cartridge may not be individually disposable or serviceable. Therefore, failure of one component in a cartridge means that the entire cartridge becomes unusable. For a conventional gas-cooled plasma arc torch, in the process of starting the torch using the contact start method, the resulting pilot arc can produce wear on the nozzle, which reduces the useful life of the consumable component for both manual and robotic cutting applications. More specifically, during the pilot arc mode for operating a gas-cooled plasma arc torch (e.g., prior to arc transfer to the workpiece), pilot arc is formed between the electrode and the inner face of the nozzle surrounding the nozzle exit orifice. Then the pilot arc quickly proceeds through the nozzle exit orifice and remains attached to the outer nozzle face surrounding the nozzle exit orifice. During this period and before arc transfers to the workpiece, the pilot arc current and oxygen in the process gas can produce rapid wear to the nozzle around the outlet of the nozzle exit orifice. Such nozzle wear degrades the torch's cutting capability while severely limiting consumable life.

In some cases, nozzle life can be extended in manual and robotic cutting applications by switching the process gas from an oxidizing gas (e.g., air) to a non-oxidizing gas (e.g., N2, F₅, etc.) when the pilot arc is attached to the nozzle. However, non-oxidizing gases are significantly more expensive to use than air as a processing gas, which is the reason that most manual plasma cutting torches use air as the process gas. In some cases, attempts have been made to extend nozzle life by limiting the pilot current to reduce wear, but this can result in issues related to subsequent transferring of the arc to the workpiece.

Therefore, in practice, for applications with significant pilot arc time, the nozzle and/or the entire consumable cartridge needs to be changed long before other consumables (e.g., the electrode) have reached the end of its life. In general, high pilot arc time can result in premature nozzle wear and low overall consumable cartridge life, thereby increasing consumable cost. Examples of applications that require significant pilot arc time include, but are not limited to, an operator using the torch as a light source, robotic applications with imprecise edge location, grate cutting, robotic aluminum cast cutting, and trimming operations where average pilot arc time per start can be 5 to 10 times that of a traditional cut table application. For instance, in robotic applications where cartridges are installed inside of plasma arc torches, less than 1% of the cartridges are used up due to electrode blow out. Instead in many cases, cartridges are replaced due to premature nozzle wear. Such premature needs for cartridge replacement limit the advantages of cartridge usage. In applications where consumables are individually replaceable (i.e., not a part of a cartridge), customers can use up to 2 nozzles per electrode.

Therefore, systems and methods are needed to reduce nozzle wear in a gas-cool plasma arc processing system without increasing cost or compromising processing performance.

### SUMMARY

The present invention features a gas supply system for a gas-cooled plasma arc processing system configured to toggle/switch between supply of a non-oxidizing and an oxidizing gas to a plasma arc torch based on monitoring of one or more arc conditions associated with the torch. In some embodiments, the gas supply system is configured to selectively provide/permit flow of different process gases to the plasma arc torch via a gas inlet of the plasma power supply based on monitoring of the system and the current stage of the plasma process. For example, the gas supply system can automatically switch between nitrogen (a non-oxidizing gas) and air (an oxidizing gas) based on detection of pilot arc existence at the torch, which indicates whether the torch is being operated in the pilot arc mode or transferred arc mode. In some embodiments, the plasma arc material processing system of the instant invention uses a single gas hose as the torch lead to supply a gas to the plasma arc torch, where this gas can be split at the torch to support multiple functions, including as a plasma gas, a shield gas and/or an electrode cooling gas. If the gas supplied acts as a cooling gas, no other cooling fluid is supplied to the plasma arc torch. In some embodiments, the torch of this type can be operated at a transferred arc current of below about 130 amps. In some embodiments, the system can purge the torch lead connected to the plasma arc torch with a non-oxidizing gas prior to and/or after torch operation. It is observed that the low volumes of gas in the torch lead coupled with high flow process gas flow rates result in quick purge times. In some embodiments, the gas supply system is retrofitted into an existing gas-cooled plasma arc processing system as an add-on accessory. Alternatively, the gas supply system can be integrally built into the plasma arc processing system, such as integrated with the power supply of the plasma arc processing system.

In one aspect, a gas supply system for a gas-cooled plasma arc material processing system is provided. The gas supply system includes a gas pressure control valve disposed relative to a gas-cooled plasma arc torch in the plasma arc material processing system. The gas supply system also includes a gas selector valve fluidly connected to (i) at least two gas supplies and (ii) a torch lead coupled to the plasma arc torch. The gas selector valve is located upstream from the plasma arc torch, the torch lead and the gas pressure control valve. In some embodiments, the gas selector valve is positioned external to the plasma arc torch. The gas supply system further includes a switching device operably connected to the gas selector valve. The switching device is configured to manipulate a position of the gas selector valve to supply a gas from one of the at least two gas supplies to the plasma arc torch via the lead. The gas selected is based on an electrical signal automatically generated by the material processing system indicating at least one operating condition of the plasma arc torch.

In another aspect, a computer-implemented method for reducing wear on a nozzle in a gas-cooled plasma arc torch of a plasma arc material processing system. The method includes selecting, by a gas selector valve, a non-oxidizing gas for supply to the plasma arc torch via a torch lead, initiating, by the plasma arc torch, ignition of a plasma arc using the non-oxidizing gas during a pilot arc mode for operating the plasma arc torch, and automatically monitoring, by an arc monitoring device, at least one operating parameter of the plasma arc torch to detect when the plasma arc is transferred to a workpiece to process the workpiece in a transferred arc mode for operating the plasma arc torch. The method also includes automatically switching, by the gas selector valve, an oxidizing gas for supply to the plasma arc torch via the torch lead once the arc transfer is detected based on the monitoring and switching, by the gas selector valve, back to the non-oxidizing gas upon detection of initiation of ignition of another plasma arc by the plasma arc torch.

In yet another aspect, a gas supply system for a gas-cooled plasma arc material processing system is provided. The gas supply system comprises control means for controlling pressure of a gas supplied to a gas-cooled plasma arc torch in the plasma arc material processing system and selector means for selecting the gas from one of at least two gas supplies for conduction to the plasma arc torch via a torch lead. The selector means is located upstream from the torch lead, the plasma arc torch, and the control means. In some embodiments, the selector means is positioned external to the plasma arc torch. The gas supply system also includes a monitoring means configured to monitor at least one operating condition of the plasma arc torch and a switching means operably connected to the selector means. the switching means configured to manipulate the selector means to supply the gas from one of the at least two gas supplies to the plasma arc torch via the lead based on the at least one operating condition of the plasma arc torch from the monitoring means.

Any of the above aspects can include one or more of the following features. In some embodiments, the at least two gas supplies provide different gases comprising at least a non-oxidizing gas and an oxidizing gas. The switching device can actuate the gas selector valve to switch selection between the non-oxidizing gas and the oxidizing gas depending on an indication by the electrical signal of whether the plasma arc torch is in a pilot arc mode or a transferred arc mode. In some embodiments, the switching by the gas selector valve from the oxidizing gas to the non-oxidizing gas occurs when an electrode of the plasma arc torch is physically separated from the nozzle. In some embodiments, the non-oxidizing gas is supplied during a pilot arc mode to initiate ignition of a plasma arc by driving a contact start between the nozzle and an electrode of the plasma arc torch via the non-oxidizing gas.

In some embodiments, the gas supply system further includes an arc monitoring system communicatively connected to the plasma arc torch via a pilot arc return wire connected to the plasma arc torch. The arc monitoring system is configured to monitor the at least one operating condition within the plasma arc torch and send the electrical signal to the switching device based on the at least one operating condition monitored. The arc monitoring system can also include a current sensing relay in the pilot arc return wire to detect a presence of a current in the pilot arc return wire. In some embodiments, the current sensing relay is adapted to energize the switching device to manipulate the position of the gas selector valve when the current is detected by the current sensing relay, thereby allowing a non-oxidizing gas to flow to the plasma arc torch via the torch lead. The arc monitoring system can also include a radio-frequency identification (RFID) reader configured to receive a radio-frequency signal from an RFID tag coupled to a consumable component installed within the plasma arc torch. The radio-frequency signal conveys the at least one operating condition associated with the consumable component.

In some embodiments, the gas selector valve is configured to switch between the gas supplies to change a type of gas entering the torch lead as a function of time. In some embodiments, the gas selector valve is configured to automatically select and supply a nitrogen gas to the plasma arc torch, when a nitrogen cutting cartridge is detected within the plasma arc torch and the plasma arc torch is being operated in a cutting operation. In some embodiments, the gas selector valve is configured to automatically toggle between a nitrogen gas and air. For example, the nitrogen gas is automatically supplied to the plasma arc torch for a marking operation and air is automatically supplied to the plasma arc torch for a cutting operation. The plasma arc torch can include a same set of consumable components for the marking operation and the cutting operation.

In some embodiments, the gas selector valve is detachably connected to the gas supply system. In some embodiments, the gas selector valve is a MAC® bullet valve. In some embodiments, the gas selector valve is configured to permit only the gas of a substantially homogenous composition to enter the lead. In some embodiments, the substantially homogenous gas is a single type of gas. In some embodiments, the torch lead provides the substantially homogeneous gas to the plasma arc torch to function as at least two of a plasma gas, a shield gas, a blowback gas for contact starting the torch, and a gas coolant for electrode cooling.

In some embodiments, the torch lead comprises a single gas supply line. In some embodiments, the torch lead is at least about 15 feet long such that the gas selector valve is at least about 15 feet away from the plasma arc torch. In some embodiments, a volume of the torch lead in the form of a gas hose is between about 0.005 cubic feet and about 0.03 cubic feet. In some embodiments, a gas volume-to-flow ratio of the torch lead gas hose is (i) between about 0.0000115 and about 0.00005746 at ignition of a plasma arc by the plasma arc torch in a pilot arc mode, and (ii) between about 0.00006464 and about 0.000032322 during operation by the plasma arc torch in a transferred arc mode. In some embodiments, the torch lead is configured to conduct a gas with a flow rate of greater than about 350 standard cubic feet per hour (scfh), and wherein an inner diameter of the torch lead is less than about 0.27 inches.

In some embodiments, the gas supply system further includes a power supply having a gas inlet in fluid communication with the torch lead. The gas selector valve can be configured to connect to the gas inlet of the power supply to direct the selected gas to the torch lead via the power supply. The gas selector valve can be located upstream from the power supply, the torch lead and the gas pressure control valve.

In some embodiments, the at least one operating condition of the plasma arc torch comprises whether the plasma arc torch is being operated in a pilot arc mode or a transferred arc mode. In some embodiments, plasma arc system data and workpiece data for a part to be processed by the plasma arc torch of the material processing system is loaded into a processor of the material processing system.

In some embodiments, the torch lead is purged with the non-oxidizing gas at least one of before or after an operation by the plasma arc torch to process the workpiece. In some embodiments, the torch lead is purged with the non-oxidizing gas when the plasma arc is extinguished. In some embodiments, a purge time of the torch lead is about 1 second when at least one of (i) one or more consumable components are first installed inside of the torch, (ii) the plasma arc material processing system has been idle for a time period, (iii) at the end of a post flow, or (iv) when the post flow is interrupted.

In some embodiments, the gas selector valve selectively permits flows of different processing gases at different times to a gas inlet of a power supply of the plasma arc material processing system for supply to the plasma arc torch via the torch lead, where the selective permitting is based on the automatic monitoring. In some embodiments, the gas selector valve automatically selects air for supply to the plasma arc torch during the transferred arc mode if the workpiece is made of mild steel, and nitrogen or F₅ for supply to the plasma arc torch during the transferred arc mode if the workpiece is made of one of stainless steel or aluminum. In some embodiments, the gas selector valve is configured to automatically select nitrogen or F₅ when the arc monitoring device detects a nitrogen cutting cartridge installed in the plasma arc torch.

In some embodiments, a current supplied to the plasma arc torch is selectively increased during the pilot arc mode to restore a transfer height without causing wear to the nozzle. The selective increasing can depend on a type of the non-oxidizing gas used during the pilot arc mode.

In some embodiments, the automatic monitoring comprises monitoring, by the arc monitoring device, a pilot arc feedback circuit to detect presence of a current in the pilot arc feedback circuit. In some embodiments, the automatic monitoring includes transmitting, by an RFID tag coupled to a consumable component installed within the plasma arc torch, an electrical signal conveying at least one operating condition associated with the consumable component, and monitoring, by the arc monitoring device, the at least one operating condition.

It should also be understood that various aspects and embodiments of the invention can be combined in various ways. Based on the teachings of this specification, a person of ordinary skill in the art can readily determine how to combine these various embodiments. For example, in some embodiments, any of the aspects above can include one or more of the above features. One embodiment of the invention can provide all of the above features and advantages.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary configuration of a gas supply system for a plasma arc material processing system, according to some embodiments of the present invention.

FIG. 2 shows an exemplary configuration of the plasma arc material processing system of FIG. 1 with the gas selector valve of the gas supply system located outside of and in fluid communication with the gas inlet to a power supply, according to some embodiments of the present invention.

FIG. 3 shows another exemplary configuration of the plasma arc material processing system of FIG. 1, according to some embodiments of the present invention.

FIG. 4 shows an exemplary graph of gas flow rates for different processing gases used along with corresponding current usage during a plasma processing operation by the plasma arc torch of the plasma arc material processing system of FIG. 1, according to some embodiments of the present invention.

FIG. 5 shows a flow diagram illustrating an exemplary operation of the gas supply system of the plasma arc processing system of FIG. 1, according to some embodiments of the present invention.

FIG. 6 shows an exemplary process implemented by the gas supply system of the plasma arc material processing system of FIG. 1 for determining gas selection when operating the plasma arc torch, according to some embodiments of the present invention.

### DETAILED DESCRIPTION

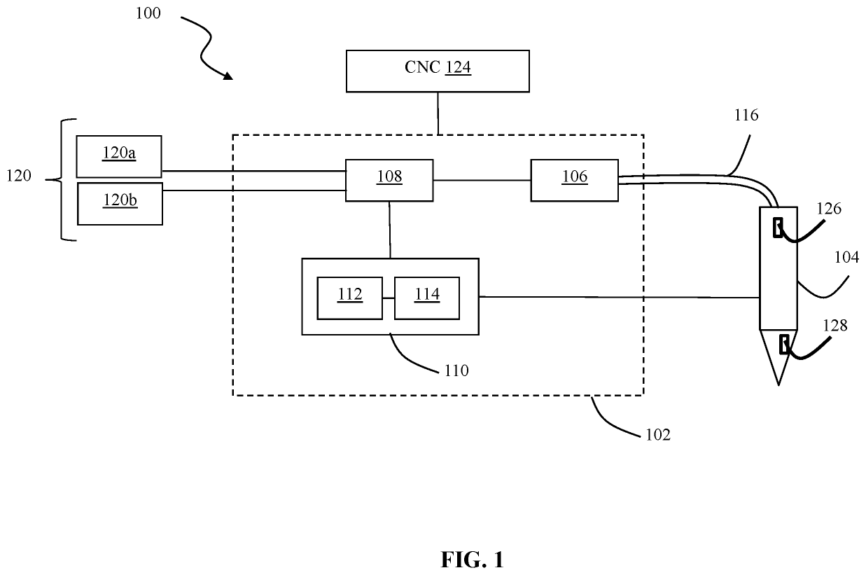

FIG. 1 shows an exemplary configuration of a gas supply system 102 of a plasma arc material processing system 100, according to some embodiments of the present invention. As shown, the gas supply system 102 is connected to and in fluid communication with a gas-cooled plasma arc torch 104 of the plasma arc material processing system 100. The gas supply system 102 includes a gas pressure control valve 106 disposed relative to the torch 104, a gas selector valve 108, and a decision system 110 that comprises a switching device 112 and an arc monitoring system 114. In some embodiments, the plasma arc torch 104 is a contact start plasma arc torch configured to operate in a pilot arc mode (for initiating/igniting a plasma arc) or a transferred arc mode (for processing a workpiece by transferring the plasma arc to the workpiece). In some embodiments, the gas supply system 102 is in electrical communication with a computer numeric controller (CNC) 124 of the plasma are material processing system 100, where the CNC 124 is used by an operator to input data for controlling operations of the plasma arc torch 104.

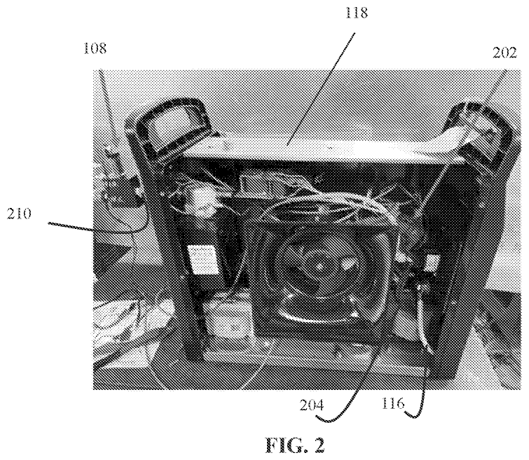

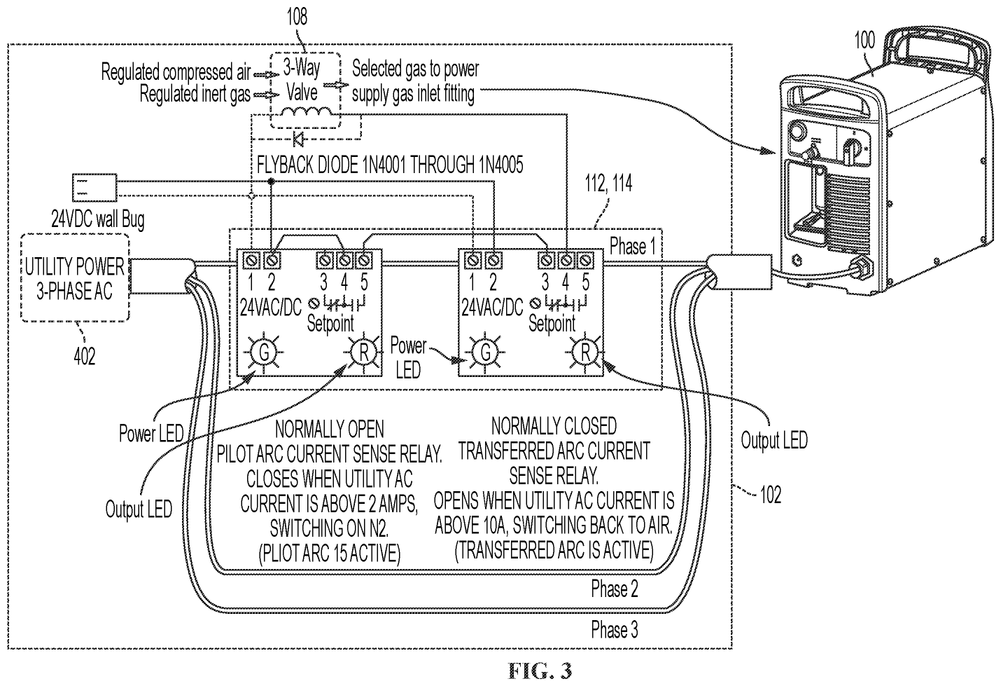

The gas selector valve 108 has at least two inputs fluidly connected to corresponding ones of at least two gas supplies 120a, 120b (collectively referred to as 120). An output of the gas selector valve 108 is fluidly connected to a torch lead 116 that is in turn coupled to the plasma arc torch 104. The gas selector valve 108 is configured to conduct a gas from one of the multiple gas supplies 120 to the plasma arc torch 104 via the torch lead 116. In some embodiments, the gas selector valve 108 is a MAC® bullet valve. In some embodiments, the gas pressure control valve 106 is disposed on the gas delivery path between the gas selector valve 108 and the torch lead 116, where the gas pressure control valve 106 is configured to regulate the pressure and/or flow rate of the gas being delivered to the plasma arc torch 104. Thus, the gas selector valve 108 can be located upstream from the torch lead 116 and the gas pressure control valve 106 and the plasma arc torch 104. In some embodiments, the gas selector valve 108 selects/switches gases among the gas supplies 120 for delivery via the torch lead 116 while the gas in the torch lead 116 is pressurized by the gas pressure control valve 106. In some embodiments, the gas selector valve 108 is positioned external to a power supply of plasma arc material processing system 100, as explained below with reference to FIGS. 2 and 3. In some embodiments, torch lead 116 comprises a single gas line between the gas pressure control valve 106 and plasma arc torch 104.

In some embodiments, each of the gas supplies 120 stores a gas of a substantially homogenous composition, such as a single type of gas (e.g., about 95% or greater pure nitrogen or a consistent mixture of air, etc.). Therefore, the gas selector valve 108 can be configured to only permit a gas of a substantially homogenous composition (e.g., a single type of gas) to enter the torch lead 116. In turn, the torch lead 116 can be a single gas supply line for supplying a single type of gas to the plasma arc torch 104. In some embodiments, the different gas supplies 120 connected to the inputs of the gas selector valve 108 provide different gases including at least a non-oxidizing gas (e.g., nitrogen or F₅ that is about 5% hydrogen and about 95% nitrogen) and an oxidizing gas (e.g., air). As an example, one of the gas supplies 120a can be air, while the other gas supply 120b can be nitrogen. In some embodiments, the substantially homogenous gas (e.g., a single type of non-oxidizing or oxidizing gas) provided to the torch 104 via the torch lead 116 is split within the torch 104 and used by the torch 104 to support multiple functions. For example, the gas can be used as at least two of a plasma gas, a shield gas, a blow back gas for separating the nozzle and electrode during contact starting the torch 104, or a gas coolant for cooling various components (e.g., the electrode) of the torch 104. In some embodiments, the gas is used for electrode cooling, as a plasma gas and as a blowback gas.

In some embodiments, the gas selector valve 108 is positioned relative to a power supply of the plasma arc material processing system 100, such as integrated with the power supply or coupled to the power supply at the gas inlet to the power supply. FIG. 2 shows an exemplary configuration of the plasma arc material processing system 100 of FIG. 1 with the gas selector valve 108 of the gas supply system 102 located outside of and in fluid communication with the gas inlet 210 to a power supply 118, according to some embodiments of the present invention. Specifically, the inputs to the gas selector valve 108 are connected to the gas supplies 120 and the output of the gas selector valve 108 is detachably connected to the gas inlet 210 of the power supply 118, which is in turn connected to the torch lead 116. In this configuration, the gas selector valve 108 can selectively manipulate the input gas flow to the torch lead 116 via the power supply 118. As shown, the gas selector valve 108 is located on the system side of the torch lead 116, such as upstream from the power supply 118, the torch lead 116 and the gas pressure control valve 106 (e.g., before any gas has left the power supply 118 and enter the torch lead 116).

Alternatively (not shown), the gas selector valve 108 can be integrated with the power supply 118, such as disposed within the housing of the power supply 118. In this configuration, the multiple gas supplies 120 are connected to the inlets of the power supply 118, within which the gas selector valve 108 is actuated to select one of the gas supplies 120 for transmission to the torch 104.

FIG. 3 shows another exemplary configuration of the plasma arc material processing system 100 of FIG. 1 where the gas supply system 102, including the gas selector valve 108, is connected to the system 100 as an add-on accessory (e.g., as a standalone plug-and-play add-on), according to some embodiments of the present invention. As shown, the gas supply system 102 is external and wired to the to the plasma arc material processing system 100 to monitor the operating conditions of the plasma arc material processing system 100 and to selectively provide/permit flow of different processing gases to the gas inlet of the plasma arc material processing system 100 based on the monitoring of power of the plasma process. As shown, the plasma arc material processing system 100 can be powered by a three-phase power supply 402 providing three separate currents separated by 120 degrees. The gas supply system 102 can be coupled to the connection between the power supply 402 and the plasma arc material processing system 100 to detect an operating mode of the plasma arc material processing system 100, which will be explained below in detail. Connecting the gas supply system 102 as an add-on accessory to the plasma arc material processing system 100 enables existing plasma arc systems to be retrofitted (e.g., field upgraded) to extend the nozzle life of consumables in high pilot arc on applications.

Referring back to FIG. 1., in some embodiments, the switching device 112 of the decision system 110, which is a combination of hardware and software components, is in data communication with the gas selector valve 108 and configured to direct/manipulate a position of the gas selector valve 108 to select a particular gas supply from the multiple gas supplies 120 for delivery to the plasma arc torch 104 via the torch lead 116. The gas supply is determined by the switching device 112 based on a command in the form of an electrical signal automatically generated by the arc monitoring system 114 that indicates at least one operating condition of the plasma arc torch 104. For example, the operating condition can comprise an indication of whether the plasma arc torch 104 is being operated in the pilot arc mode or the transferred arc mode. The switching device 112 can actuate the gas selector valve 108 to switch selection between a non-oxidizing gas (e.g., nitrogen or F₅) if the torch is being operated in a pilot arc mode and an oxidizing gas (e.g., air) if the torch 104 is being operated in a transferred arc mode.

In some embodiments, the arc monitoring system 114 of the decision system 110, which is a combination of hardware and software components, is configured to monitor/detect an operating condition of the plasma arc torch 104 and transmit an electrical signal to the switching device 112 conveying the operating condition. Based on the signal, the switching device 112 can then selectively manipulate the position of the gas selector valve 108 to choose the appropriate gas for supply to the torch 104. To perform such monitoring, the arc monitoring system 114 can be communicatively connected to the plasma arc torch 104 via a pilot arc return wire attached to the torch 104. For example, as shown in FIG. 2, the arc monitoring system 114 can include a current sensing relay 202 coupled to the pilot arc return wire 204 to detect the presence of a current in the pilot arc return wire 204. Both the current sensing relay 202 and the pilot arc return wire 204 can be located within the power supply 118. Detection of the presence of a current on the pilot arc return wire 204 by the current sensing relay 202 indicates that the torch 104 is operating in the pilot arc mode, in which case the current sensing relay 202 can send an appropriate electrical signal to the switching device 112, based on which the switching device 112 can energize the gas selector valve 108 to select a non-oxidizing gas (e.g., nitrogen) to flow to the plasma arc torch 104 via the torch lead 116. In general, a non-oxidizing gas is supportive of a pilot arc in the pilot arc mode and is not damaging to the nozzle of the plasma arc torch 104. Alternatively, when the current sensing relay 202 does not detect a current in the pilot arc return wire 204, no electrical signal is sent to the switching device 112 and the gas selector valve 108 is not energized, in which case the gas selector valve 108 can choose an oxidizing gas (e.g., air) to flow to the plasma arc torch 104 via the torch lead 116. In general, the lack of current in the pilot arc return wire 204 indicates that the torch 104 is operating in the transferred arc mode (i.e., processing a workpiece) and an oxidizing gas would be an appropriate choice as the processing gas.

In some embodiments as illustrated in the configuration of FIG. 3, the gas supply system 102, including the arc monitoring system 114, the switching device 112 and the gas selector valve 108, is connected to the material processing system 100 as an add-on component and is configured to determine if the system 100, including the torch 104, is operating in the pilot arc mode or the transferred arc mode by monitoring the level of incoming power supplied to the material processing system 100 from the external power supply 402. For example, if the incoming power exceeds (e.g., is below) a predetermined power threshold, this indicates to the arc monitoring system 114 that the torch 104 is operating in the pilot arc mode and the arc monitoring system 114 is adapted to communicate with the switching device 112 to affect selection of a non-oxidizing gas by the gas selector valve 108. This approach provides an alternative method for detecting the operation mode of the torch 104 illustrated in FIG. 2, which monitors the current on the current return wire 204 to determine the operating mode of the torch 104.

Returning to FIG. 1, in some embodiments, the arc monitoring system 114 can include a radio-frequency identification (RFID) reader 126, as shown in FIG. 1, configured to receive a radio-frequency signal from an RFID tag 128 coupled to a consumable component installed within the plasma arc torch 104. The RFID tag 128 can be readable and/or writable such that it stores latest data regarding one or more operating conditions associated with the consumable component throughout an operation of the torch 104 (e.g., whether the torch 104 is operating in a pilot arc mode or a transferred arc mode). In some embodiments, the RFID tag 128 identifies the consumable installed, such as a nitrogen cutting or marking cartridge, in which case the arc monitoring system 114 can actuate the gas selector valve 108 to automatically select nitrogen for supply to the torch 104. Even though the RFID reader 126 is shown in FIG. 1 to be attached to the body of the torch 104, the RIFID reader 126 can be located anywhere in the plasma arc material processing system 100 (e.g., in the CNC 124 or the switching device 114), as long as it can maintain radio-frequency communication with the RFID tag 128.

In some embodiments, the arc monitoring system 114 can be in electrical communication with the CNC 124 of the plasma arc material processing system 100 to detect changes in operating conditions associated with the plasma arc torch 104 that can affect the type of gas delivered to the torch 104. For example, the CNC 124 can be programmed by an operator to instruct the power supply 118 or other components of the material processing system 100 to set certain operating parameters, where these instructions can also be transmitted to the arc monitoring system 114 for gas determination purposes. For example, an operator can input a process selection command via the CNC 124 to change motion of the plasma arc torch 104 to perform rapid mark cut transitions, in which case the arc monitoring system 114 can detect the operator input by communicating with the CNC 124 and actuate the gas selector valve 108 accordingly. In some embodiments, commands from the CNC 124 override other operating conditions detected by the arc monitoring system 114. For example, if the arc monitoring system 114 receives a command from the CNC 124 that the torch 104 is switching from a cutting operation to a marking operation, the gas selector valve 108 is adapted to respond by selecting a nitrogen gas for supply to the torch 104 to support the next marking operation even if the arc monitoring system 114 is still detecting the transferred arc mode of a current cutting operation by the torch 104.

In general, operating condition changes detectable by the arc monitoring system 114 (using the different approaches described above) can include installation of certain types of consumable components in the torch 104 (e.g., installation of a dedicated nitrogen cutting or marking cartridge), certain processing operations to be performed by the torch 104 (e.g., marking or cutting operations), or certain types of workpieces to be processed (e.g., mild steel or stainless steel/aluminum), or a combination thereof. For example, depending on the operation being performed by the plasma arc material processing system 100, the gas selection valve 108, in conjunction with the arc monitoring system 114, can respond to the type of cartridge detected (e.g., via an RFID tag inside of the torch 104 or on the cartridge); a process selection command for rapid mark cut transitions (e.g., via inputs from the CNC 124), or to the sensing of pilot arc current (e.g., via the current sensing relay 202 in the pilot arc return wire 204). The arc monitoring system 114 can in turn communicate with the switching device 112 to automatically actuate the gas selector valve 108 to deliver different process gases to the torch 104 via the torch lead 116 at different times in accordance with the different operating conditions.

As an example, if the arc monitoring system 114 detects the installation of a nitrogen cutting cartridge in the torch 104, such as via communication with an RFID tag coupled to the cartridge, the gas selector valve 108 can be actuated to provide nitrogen to the torch 104 when a cutting operation by the torch 104 in the transferred arc mode is also detected. As another example, if the arc monitoring system 114 detects that the workpiece being processed is made from mild steel, the switching device 112 can actuate the gas selector valve 108 to dispense air for cutting the mild steel workpiece during the transferred arc mode. In contrast, if the arc monitoring system 114 detects that the workpiece is made from stainless steel and/or aluminum, the switching device 112 can actuate the gas selector valve 108 to dispense nitrogen or F₅ for cutting the workpiece during the transferred arc mode to achieve improved cut quality. Detection of the type of workpiece by the arc monitoring system 114 can be accomplished by communicating with the CNC 124, which has plasma arc system data and workpiece data loaded thereon.

In yet another example, when the arc monitoring system 114 detects that the plasma arc torch 104 is being used for a marking operation, such as via communication with the CNC 124, the switching device 112 can actuate the gas selector valve 108 to select a nitrogen gas for delivery to the torch 104 in support of the marking operation in the transfer arc mode, which may mean that gas selector valve 108 needs to be able to rapidly switch from another gas used in a previous operation (e.g., from air when the torch 104 is used in a previous cutting operation). The gas selector valve 108 can automatically toggle between selection of the nitrogen gas and air for delivery to the torch 104, such that the nitrogen gas is automatically supplied to the torch 104 for a marking operation and air is automatically supplied to the torch 104 for a cutting operation. For both operations, components of the torch 104 can remain substantially the same, such as having the same set of consumable components for the marking operation and the cutting operation, including having the same cutting cartridge for both operations. For example, a cutting cartridge can be used in both nitrogen marking and air cutting operations. With the same cutting cartridge, the material processing system 100 can actuate the gas selector valve 108 to choose a nitrogen gas for supply to the torch 104, and coupled with a low current setting, to produce a fine mark on the workpiece surface. Then the material processing system 100 can increase the current setting and cause the gas selector valve 108 to switch to air to cut the workpiece, or vice versa. This can be an automated process in which the gas supply system 102 communicates with the CNC 124 of the material processing system 100 that receives a command from system data selecting the marking or cutting process for each programmed move. Alternatively, the gas supply system 102 can be operator controlled, where the operator overrides automatic detection and actuates the gas selector valve 108 to choose the desired gas. In general, the gas supply system 102 can provide automated gas switching control and capability in response to rapid process changeovers by the torch 104 (e.g., nitrogen marking to air cutting and vice versa in mechanized applications), while the torch 104 has the same set of consumable components for the different processes.

Embodiments of the instant invention permit longer consumable life in cutting and marking applications with significant pilot arc time by reducing the wear on the nozzle during the piloting phase. This can be accomplished by first using a non-oxidizing gas to develop, support, and sustain the pilot arc and then switching to a second gas (e.g., automatically upon detection of arc transfer) for the actual plasma processing operation. In some embodiments, the gas selector device 108 is actuated by the switching device 112 to switch back to the first non-oxidizing gas upon determination that the arc transfer is complete and the pilot arc is present again and/or arc extinguishment is occurring. In some embodiments, to further prolong consumable life, the CNC 124 and/or the power supply 118 can lower arc transfer heights when a non-oxidizing gas (e.g., nitrogen) is selected and used during the pilot arc mode. More specifically, in cooperating with the gas supply system 102, the CNC 124 can selectively increase the pilot arc current supplied to the torch 104 during the pilot arc mode to restore the transfer height without causing nozzle pilot arc wear. The selective increasing of the pilot arc current can be dependent on the type of the non-oxidizing gas used during the pilot arc mode.

In another aspect, the gas selector valve 108 is actuated to switch among the gas supplies 120 to change a type of the gas entering the torch lead 116 as a function of time. The gas supply system 102 of the instant invention, coupled with relatively high gas flow rate through the torch lead 116 and small cross-sectional torch lead dimensions, allows fast gas switching to quickly purge the torch lead 116 as well as to achieve quick gas change at the plasma arc torch 104, despite the gas selector valve 108 being positioned well upstream from the torch 104. In some embodiments, the torch lead 116 is at least about 15 feet long such that the gas selector valve 108 is at least about 15 feet away from the plasma arc torch 104. For example, the gas selector valve 108 can be located about 15 feet to about 75 feet from the torch 104.

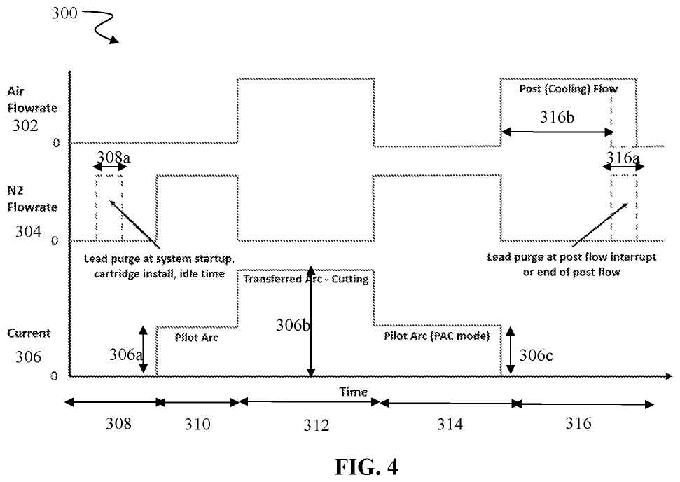

FIG. 4 shows an exemplary graph 300 of gas flow rates for different processing gases used (i.e., air 302 and nitrogen 304) along with corresponding current usage 306 during a plasma processing operation by the plasma arc torch 104 of the plasma arc material processing system 100 of FIG. 1, according to some embodiments of the present invention. As shown, during system startup 308 (i.e., prior to the initiation of a pilot arc by the torch 104) when current usage 306 by the torch 104 is zero, the torch lead 116 can be purged by a non-oxidizing gas (e.g., nitrogen 304) as chosen by the gas selector valve 108 for a short duration 308a, such as on the order of 1 second. Thereafter, during the pilot arc mode 310 for operating the plasma arc torch 104, the gas selector valve 108 can again introduce the non-oxidizing gas (e.g., nitrogen 304) to the torch 104 for use by the torch 104 to initiate a pilot arc. During the pilot arc mode 310, a certain amount of pilot arc current 306a is used by the torch 104 to initiate the arc. As described above, the pilot arc current 306a can be detected by the decision system 110 to automatically actuate the gas selector valve 108 to dispense the nitrogen gas. Thereafter, during the transferred arc mode 312 for operating the torch 104, the gas selector valve 108 can be actuated to substantially exclusively select an oxidizing gas (e.g., air 302) for introduction to the torch 104 that is used by the torch 104 to transfer the plasma arc to a workpiece to process (e.g., cut, mark or gouge) the workpiece. During the transferred arc mode 312, a certain amount of transferred arc current 306b is used by the torch 104 for the processing operation, which is typically higher than the pilot arc current 306a. As described above, the transferred arc current 306b can be detected by the decision system 110 to automatically actuate the gas selector valve 108 to dispense air during the transferred arc mode 312. After the transferred arc mode 312, the torch 104 can be operated in a pilot arc control (PAC) mode 314 that has substantially the same operating conditions and characteristics as the pilot arc mode 310. The PAC mode 314 can be used for cutting a grate or non-continuous flash on castings, etc. During the PAC mode 310, the pilot arc current 306c generated can be detected by the decision system 110 to automatically actuate the gas selector valve 108 to dispense the nitrogen gas for supply to the torch 104.

After the completion of the PAC mode 314, the torch 104 can initiate a cool-down, post-flow mode 316, during at least a portion of which (i.e., duration 316b) no electrical current or plasma is generated, and an oxidizing gas flow, such as air flow 302 as shown in FIG. 4, is supplied to the torch 104 to cool the consumable parts so the parts approach about room temperature. During another portion (duration 316a) of the post flow mode 316, such as the end of the post flow mode 316, the torch lead 116 can be purged with the non-oxidizing gas (e.g., nitrogen 304) as chosen by the gas selector valve 108 for a short duration 316a, such as on the order of 1 second. This torch lead purging with the non-oxidizing gas at the end of the post flow mode 316 is implemented after the oxidizing gas ceases to be supplied to the torch 104. Alternatively, torch lead purging can be implemented at a post-flow interrupt (also represented by duration 316a), at which the system is in the post-flow mode 316 and the operator would like to restart the torch 104 by interrupting the post-flow torch component cooling, leading to a drop in torch pressure to allow the electrode come into contact with the nozzle to restart the arc ignition sequence along with a renewed pilot arc attachment to the nozzle. In some embodiments, relative to the entire duration of the post flow mode 316, about 80% of duration 316 (e.g., duration 316b) involves supplying air 302 as a slug flow to the torch 104 in support of cooling the consumable parts to about room temperature, and about 20% of duration 316 (e.g., duration 316a) involves supplying the nitrogen gas 304 as another slug flow to the torch 104 in support of post-flow interrupt or torch lead purging at the end of torch component cooling. In some embodiments, torch lead purging is implemented not only at the system startup 308 and/or during the post-flow mode 316, but also when consumable components are first installed inside of the torch 104 and/or when the system 100 has been idle for a predefined time period. In some embodiments, the gas selector valve 108 is actuated to select a non-oxidizing gas to the torch lead 116 to purge the torch lead 116 based on detection by the arc monitoring system 112 of when the system 100 is powered up (thereby detecting the system startup mode 308), when a post-flow timer is about to expire (thereby detecting the end of the post-flow mode 316) and/or when a plasma start is sent during the post-flow mode 316 (thereby detecting a post-flow interrupt).

As explained above with reference to FIG. 4, the gas selector valve 108 can be manipulated during system startup 308 to implement purging of the torch lead 116 for a short duration 308a using a non-oxidizing gas to prevent damage to the nozzle by removing any remnant oxidizing gas from the hose of the torch lead 116. Table 1 below shows some exemplary estimated lengths of time to purge a torch lead 116 of various lengths, ranging from about 15 feet to about 75 feet, during system startup 308. The torch lead 116 used to generate the results of Table 1 has an inner diameter of less than about 0.27 inches and is configured to conduct a gas with a flow rate of greater than about 350 standard cubic feet per hour (scfh). These estimated lengths of time are for a standard gas-cooled plasma arc processing system, where the torch lead 116 is purged with nitrogen at the ambient pressure (e.g., about 14.7 psia). In some embodiments, the system 100 knows the torch lead length installed on the power supply 118 and can set the required purge time based on the lead length.

TABLE 1

| Lead | Gas | Gas | Gas | Gas Flow | Purge |
|---|---|---|---|---|---|
| Length | Tube ID | Pressure | Volume | Rate | Time |
| (ft) | (in) | (psia) | (ft3) | (scfh) | (s) |
| 15 | 0.265 | 14.7 | 0.00575 | 500 | 0.04 |
| 25 | 0.265 | 14.7 | 0.00958 | 500 | 0.07 |
| 35 | 0.265 | 14.7 | 0.01341 | 500 | 0.10 |
| 50 | 0.265 | 14.7 | 0.01915 | 500 | 0.14 |
| 75 | 0.265 | 14.7 | 0.02873 | 500 | 0.21 |

As shown in Table 1, the volume of gas conducted by the torch lead 116 is between about 0.005 cubic feet and about 0.03 cubic feet for torch lead lengths ranging from about 15 feet to about 75 feet. As shown in Table 1, the purge times during system startup 308 at ambient pressure are relatively short, ranging between about 0.04 seconds to about 0.21 seconds. The relatively small volume of gas in the hose of the torch lead 116 together with the typical gas flow rate of nitrogen (i.e., about 500 scfh) enables gas purge times of tenths of a second on startup at ambient pressure, despite any potential long distance between the gas selector valve 108 and the torch 104.

As explained above with reference to FIG. 4, the gas selector valve 108 can also be manipulated during the cool-down, post-flow mode 316 to implement purging of the torch lead 116 for a short duration 316a using a non-oxidizing gas. Table 2 below shows some exemplary estimated lengths of time to purge a torch lead 116 of the same dimensions as that used to generate the results of Table 1. These estimated lengths of time are for a standard gas-cooled plasma arc processing system, where the torch lead 116 is purged with nitrogen at an operating pressure of about 82.7 psia.

TABLE 2

| Lead | Gas | Gas | Gas | Gas Flow | Purge |
|---|---|---|---|---|---|
| Length | Tube ID | Pressure | Volume | Rate | Time |
| (ft) | (in) | (psia) | (ft3) | (scfh) | (s) |
| 15 | 0.265 | 82.7 | 0.03232 | 500 | 0.23 |
| 25 | 0.265 | 82.7 | 0.05387 | 500 | 0.39 |
| 35 | 0.265 | 82.7 | 0.07542 | 500 | 0.54 |
| 50 | 0.265 | 82.7 | 0.10774 | 500 | 0.78 |
| 75 | 0.265 | 82.7 | 0.16161 | 500 | 1.16 |

As shown in Table 2, the volume of gas conducted by the torch lead 116 is between about 0.03 cubic feet and about 0.17 cubic feet for torch lead lengths ranging from about 15 feet to about 75 feet. As shown in Table 2, the purge times post flow 316 at an operating pressure are also relatively short, ranging between about 0.23 seconds to about 1.16 seconds, despite any potential long distance between the gas selector valve 108 and the torch 104.

In some embodiments, a gas-volume-to-flow ratio of the torch lead 116 is (i) between about 0.0000115 and about 0.00005746 at ignition of a plasma arc by the plasma arc torch 104 in the pilot arc mode 310, and (ii) between about 0.00006464 and about 0.000032322 during operation by the plasma arc torch 104 in the transferred arc mode 312.

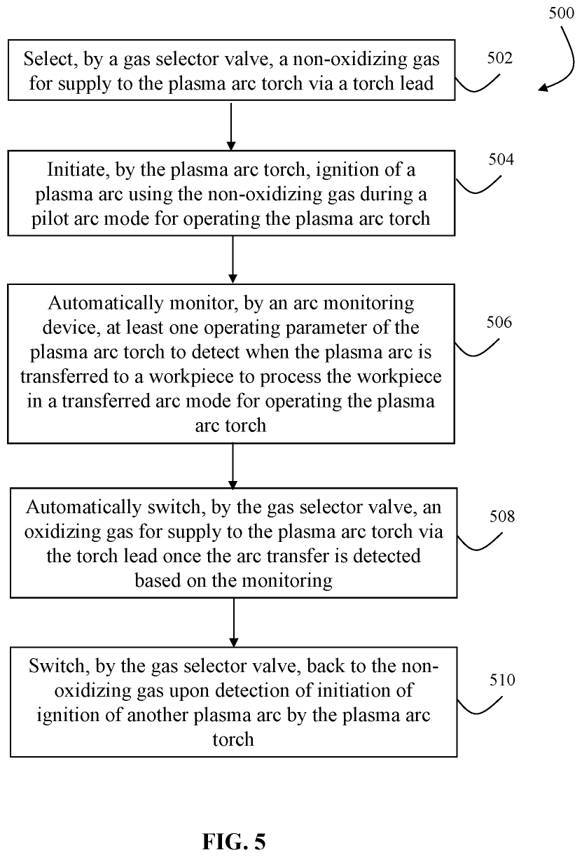

FIG. 5 shows a flow diagram illustrating an exemplary operation of the gas supply system 102 of the plasma arc processing system 100 of FIG. 1, according to some embodiments of the present invention. The process 500 starts with the arc monitoring system 114 detecting that the torch 104 is being operated in a pilot arc mode, in which case the switching device 112 actuates the gas selector valve 118 to select a non-oxidizing gas (nitrogen or F₅) for supply to the torch 104 via the torch lead 116 (step 502). During the pilot arc mode, the torch 104 is adapted to initiate ignition of a plasma arc by driving a contact start between the nozzle and the electrode of the torch 104 using the non-oxidizing gas (step 504). The arc monitoring system 114 can continually or periodically monitor the operating conditions of the torch 104 via one or more of the methods described above, including (i) via the current sensing relay 202 in the pilot arc return wire 204 connected to the torch 104 to detect the presence of a current in the pilot arc return wire 204, (ii) via the RFID reader 126 configured to receive information from the RFID tag 128 coupled to a consumable component disposed in the torch 104 that conveys operating conditions about the consumable component and/or the torch, or (iii) via electrical communication with the CNC 124 to detect changes in operating conditions associated with the plasma arc torch 104. The CNC 124 can be loaded with plasma arc system data and workpiece data for a part for processing by the torch 104.

In some embodiments, such monitoring can allow the arc monitoring system 114 to detect when the plasma arc generated by the torch 104 is transferred to a workpiece to process the workpiece in a transferred arc mode (step 506). This detection can occur when the current in the pilot arc return wire 204 as sensed by the current sensing relay 202 drops to almost zero and/or the CNC 124 transmits instructions to switch the torch 104 to operate in the transferred arc mode. Once the transferred arc mode is detected by the arc monitoring system 114, the switching device 112 actuates the gas selector valve 108 to automatically switch gas selection to an oxidizing gas (e.g., air) for supply to the plasma arc torch 104 via the torch lead 116 (step 508). By a similar procedure, the gas selector valve 108 can switch back to dispensing the non-oxidizing gas upon detection of (i) initiation of ignition of another plasma arc by the plasma arc torch in another pilot arc mode or (ii) renewed pilot arc attachment to the nozzle of the torch 104 in a post-flow interrupt (step 510). In general, the gas selector valve 108 can be actuated to flow different processing gases at different times to the plasma arc torch 104 via the torch lead 116 based on the automatic monitoring over time. For example, the gas selector valve 108 can select between a nitrogen gas and air for supply to the plasma arc torch based on the automatic monitoring.

In some embodiments, once the arc monitoring system 114 detects that the torch 104 is being operated in the transferred arc mode, the arc monitoring system 114 is able to determine the type of workpiece being processed by the torch 104, e.g., via communication with the CNC 124. If the workpiece is made of mild steel, the switching device 112 can actuate the gas selector valve 108 to select air for supply to the plasma arc torch during the transferred arc mode. Alternatively, if the workpiece is made of one of stainless steel or aluminum, the switching device 112 can actuate the gas selector valve 108 to select nitrogen or F₅ for supply to the plasma arc torch during the transferred arc mode. In some embodiments, the gas selector valve 108 is configured to automatically select nitrogen or F₅ when the arc monitoring device detects a nitrogen cutting or marking cartridge installed in the torch 104 and the torch is being operated in the transferred arc mode.

In some embodiments, the torch lead 116 can be purged with the non-oxidizing gas before and/or after an operation by the torch 104 to process the workpiece. As explained above with reference to FIG. 4, the torch lead can be purged for a short duration 308a at system startup 308 prior to initiating the plasma arc or for a short duration 316a after the plasma arc is extinguished during post flow 316. The short duration 308a, 316a can be on the order of 1 second, as evidenced in Tables 1 and 2. In some embodiments, purging of the torch lead 116 can also occur upon detection of one or more of the following conditions: (i) one or more consumable components are first installed inside of the torch 104, (ii) the plasma arc material processing system has been idle for a time period, and/or (iii) when the post flow is interrupted.

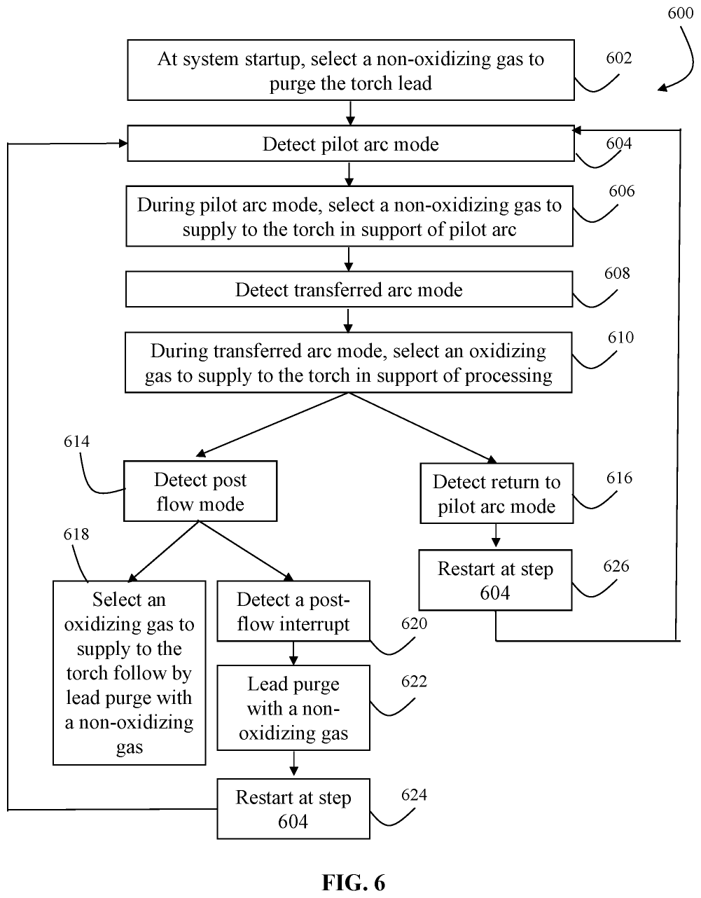

FIG. 6 shows an exemplary process 600 implemented by the gas supply system 102 of the plasma arc material processing system 100 of FIG. 1 for determining gas selection when operating the plasma arc torch 104, according to some embodiments of the present invention. At step 602 of process 600, after system startup is detected by the arc monitoring system 114 of the gas supply system 102, the gas selector valve 108 can be actuated by the switching device 112 to choose a non-oxidizing gas (e.g., nitrogen) to supply to the hose of the torch lead 116 to briefly purge the torch lead 116, as explained above with reference to FIG. 4 and Tables 1 and 2. After the pilot arc mode is detected by the arc monitoring system 114 (step 604), such as detection of a current in the pilot arc return wire 204, the gas selector valve 108 can be actuated by the switching device 112 to again choose a non-oxidizing gas (e.g., nitrogen) for supply to the torch 104 via the torch lead 116 in support of pilot arc generation (step 606). After the pilot arc mode, once the arc monitoring system 114 detects operation by the torch 104 in the transferred arc mode (step 608), such as detecting a lack of current (or current below a certain threshold) in the pilot arc return wire 204, the gas selector valve 108 can be actuated by the switching device 112 to switch to an oxidizing gas (e.g., air) for supply to the torch 104 via the torch lead 116 (step 610) in support of plasma arc transfer (e.g., cutting) of a workpiece. At the conclusion of the transferred arc mode, the material processing system 100 can either enter the post-flow mode (step 614) to cool the torch components to about room temperature or enter the pilot arc mode again (step 616) to initiate the next processing operation. If the arc monitoring system 114 detects that the torch 104 is being operated in the post-flow mode, an oxidizing gas (e.g., air) can be supplied to the torch 104 for the purpose of cooling the consumable components, followed by a quick torch lead purge with a non-oxidizing gas as automatically selected by the gas selector valve 108 (step 618). Alternatively, in the post-flow mode, if the arc-monitoring system 114 detects a post-flow interrupt where the operator is attempting to reignite the arc during post flow (step 620), the gas selector valve 108 is actuated to provide a quick torch lead purge with a non-oxidizing gas, such as nitrogen (step 622), as a part of restarting the torch (step 624), which leads to the reiteration of process 600 at step 604. If the arc monitoring system 114 enters the pilot arc mode again at the end of the cutting operation (step 616), the system 100 restarts or the torch is cast trimming or interrupted cutting and comes to a transferable distance from the workpiece (step 626), which leads to the reiteration of process 600 at step 604.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

1. A gas supply system for a gas-cooled plasma arc material processing system, the gas supply system comprising:
a gas pressure control valve disposed relative to a gas-cooled plasma arc torch in the plasma arc material processing system;
a gas selector valve fluidly connected to (i) at least two gas supplies and (ii) a torch lead coupled to the plasma arc torch, the gas selector valve located upstream from the plasma arc torch, the torch lead and the gas pressure control valve; and
a switching device operably connected to the gas selector valve, the switching device configured to manipulate a position of the gas selector valve to supply a gas from one of the at least two gas supplies to the plasma arc torch via the lead, the gas selected based on an electrical signal automatically generated by the material processing system indicating at least one operating condition of the plasma arc torch.

2. The gas supply system of claim 1, wherein the at least two gas supplies provide different gases comprising at least a non-oxidizing gas and an oxidizing gas.

3. The gas supply system of claim 2, wherein the switching device actuates the gas selector valve to switch selection between the non-oxidizing gas and the oxidizing gas depending on an indication by the electrical signal of whether the plasma arc torch is in a pilot arc mode or a transferred arc mode.

4. The gas supply system of claim 1, further comprising an arc monitoring system communicatively connected to the plasma arc torch via a pilot arc return wire connected to the plasma arc torch, the arc monitoring system configured to monitor the at least one operating condition within the plasma arc torch and send the electrical signal to the switching device based on the at least one operating condition monitored.

5. The gas supply system of claim 4, wherein the arc monitoring system includes a current sensing relay in the pilot arc return wire to detect a presence of a current in the pilot arc return wire.

6. The gas supply system of claim 5, wherein the current sensing relay is adapted to energize the switching device to manipulate the position of the gas selector valve when the current is detected by the current sensing relay, thereby allowing a non-oxidizing gas to flow to the plasma arc torch via the torch lead.

7. The gas supply system of claim 4, wherein the arc monitoring system includes a radio-frequency identification (RFID) reader configured to receive a radio-frequency signal from an RFID tag coupled to a consumable component installed within the plasma arc torch, the radio-frequency signal conveying the at least one operating condition associated with the consumable component.

8. The gas supply system of claim 1, wherein the gas selector valve is detachably connected to the gas supply system.

9. The gas supply system of claim 1, further comprising a power supply having a gas inlet in fluid communication with the torch lead, wherein the gas selector valve is configured to connect to the gas inlet of the power supply to direct the selected gas to the torch lead via the power supply, wherein the gas selector valve is located upstream from the power supply, the torch lead, the gas pressure control valve, and the plasma arc torch.

10. The gas supply system of claim 1, wherein the gas selector valve is configured to permit only the gas of a substantially homogenous composition to enter the lead.

11. The gas supply system of claim 10, wherein the substantially homogenous gas is a single type of gas.

12. The gas supply system of claim 10, wherein the torch lead provides the substantially homogeneous gas to the plasma arc torch to function as at least two of a plasma gas, a shield gas, a blowback gas for contact starting the torch, and a gas coolant for electrode cooling.

13. The gas supply system of claim 1, wherein the gas selector valve comprises a MAC® bullet valve.

14. The gas supply system of claim 1, wherein the torch lead comprises a single gas supply line.

15. The gas supply system of claim 1, wherein the torch lead is at least about 15 feet long such that the gas selector valve is at least about 15 feet away from the plasma arc torch.

16. The gas supply system of claim 1, wherein a volume of the torch lead is between about 0.005 cubic feet and about 0.03 cubic feet.

17. The gas supply system of claim 1, wherein a volume-to-flow ratio of the torch lead is (i) between about 0.0000115 and about 0.00005746 at ignition of a plasma arc by the plasma arc torch in a pilot arc mode, and (ii) between about 0.00006464 and about 0.000032322 during operation by the plasma arc torch in a transferred arc mode.

18. The gas supply system of claim 1, wherein the gas selector valve is configured to switch between the gas supplies to change a type of gas entering the torch lead as a function of time.

19. The gas supply system of claim 1, wherein the torch lead is configured to conduct a gas with a flow rate of greater than about 350 standard cubic feet per hour (scfh), and wherein an inner diameter of the torch lead is less than about 0.27 inches.

20. The gas supply system of claim 1, wherein the at least one operating condition of the plasma arc torch comprises whether the plasma arc torch is being operated in a pilot arc mode or a transferred arc mode.

21. The gas supply system of claim 1, wherein the gas selector valve is configured to automatically select and supply a nitrogen gas to the plasma arc torch, when a nitrogen cutting cartridge is detected within the plasma arc torch and the plasma arc torch is being operated in a cutting operation.

22. The gas supply system of claim 1, wherein the gas selector valve is configured to automatically toggle between a nitrogen gas and air, such that the nitrogen gas is automatically supplied to the plasma arc torch for a marking operation and air is automatically supplied to the plasma arc torch for a cutting operation, wherein the plasma arc torch includes a same set of consumable components for the marking operation and the cutting operation.

23. A computer-implemented method for reducing wear on a nozzle in a gas-cooled plasma arc torch of a plasma arc material processing system, the method comprising:
selecting, by a gas selector valve, a non-oxidizing gas for supply to the plasma arc torch via a torch lead;
initiating, by the plasma arc torch, ignition of a plasma arc using the non-oxidizing gas during a pilot arc mode for operating the plasma arc torch;
automatically monitoring, by an arc monitoring device, at least one operating parameter of the plasma arc torch to detect when the plasma arc is transferred to a workpiece to process the workpiece in a transferred arc mode for operating the plasma arc torch;
automatically switching, by the gas selector valve, an oxidizing gas for supply to the plasma arc torch via the torch lead once the arc transfer is detected based on the monitoring; and
switching, by the gas selector valve, back to the non-oxidizing gas upon detection of initiation of ignition of another plasma arc by the plasma arc torch.

24. The computer-implemented method of claim 23, further comprising loading into a processor of the material processing system (i) plasma arc system data and (ii) workpiece data for a part to be processed by the plasma arc torch of the material processing system.

25. The computer-implemented method of claim 23, further comprising purging the torch lead with the non-oxidizing gas at least one of before or after an operation by the plasma arc torch to process the workpiece.

26. The computer-implemented method of claim 25, wherein the torch lead is purged with the non-oxidizing gas when the plasma arc is extinguished.

27. The computer-implemented method of claim 23, wherein a purge time of the torch lead is about 1 second when at least one of (i) one or more consumable components are first installed inside of the torch, (ii) the plasma arc material processing system has been idle for a time period, (iii) at the end of a post flow, or (iv) when the post flow is interrupted.

28. The computer-implemented method of claim 23, further comprising selectively permitting, by the gas selector valve, flows of different processing gases at different times to a gas inlet of a power supply of the plasma arc material processing system for supply to the plasma arc torch via the torch lead, wherein the selective permitting is based on the automatic monitoring.

29. The computer-implemented method of claim 23, further comprising selectively increasing a current supplied to the plasma arc torch during the pilot arc mode to restore a transfer height without causing wear to the nozzle, wherein the selective increasing depends on a type of the non-oxidizing gas used during the pilot arc mode.

30. The computer-implemented method of claim 23, further comprising automatically selecting, by the gas selector valve, air for supply to the plasma arc torch during the transferred arc mode if the workpiece is made of mild steel, and nitrogen or F5 for supply to the plasma arc torch during the transferred arc mode if the workpiece is made of one of stainless steel or aluminum.

31. The computer-implemented method of claim 30, wherein the gas selector valve is configured to automatically select nitrogen or F₅ when the arc monitoring device detects a nitrogen cutting cartridge installed in the plasma arc torch.

32. The computer-implemented method of claim 23, wherein the automatic monitoring comprises monitoring, by the arc monitoring device, a pilot arc feedback circuit to detect presence of a current in the pilot arc feedback circuit.

33. The computer-implemented method of claim 23, wherein the automatic monitoring comprises:
transmitting, by an RFID tag coupled to a consumable component installed within the plasma arc torch, an electrical signal conveying at least one operating condition associated with the consumable component; and
monitoring, by the arc monitoring device, the at least one operating condition.

34. The computer-implemented method of claim 23, wherein the gas selector valve is configured to selectively supply between a nitrogen gas and air to the plasma arc torch.

35. The computer-implemented method of claim 23, wherein the switching by the gas selector valve from the oxidizing gas to the non-oxidizing gas occurs when an electrode of the plasma arc torch is physically separated from the nozzle.

36. The computer-implemented method of claim 23, wherein initiating ignition of a plasma arc using the non-oxidizing gas during a pilot arc mode comprises driving a contact start between the nozzle and an electrode of the plasma arc torch via the non-oxidizing gas.

37. A gas supply system for a gas-cooled plasma arc material processing system, the gas supply system comprising:
control means for controlling pressure of a gas supplied to a gas-cooled plasma arc torch in the plasma arc material processing system;
selector means for selecting the gas from one of at least two gas supplies for conduction to the plasma arc torch via a torch lead, the selector means located upstream from the torch lead, the control means, and the plasma arc torch;
a monitoring means configured to monitor at least one operating condition of the plasma arc torch; and
a switching means operably connected to the selector means, the switching means configured to manipulate the selector means to supply the gas from one of the at least two gas supplies to the plasma arc torch via the lead based on the at least one operating condition of the plasma arc torch from the monitoring means.
